(19) United States
(12) Patent Application Publication
(10) Pub. No.: US 2003/0228197 A1
(43) Pub. Date: Dec. 11, 2003

(54) Cold metal cutting machine

(76) Inventor: Ashot Salvaryan, Los Angeles, CA (US)

Correspondence Address: J. E. McTaggart, Suite 105, 1860 Eastman Avenue, Ventura, CA, 93003, US

(21) Appl. No.: 10/164,336

(22) Filed: Jun. 7, 2002

(51) Int. Cl. B26D 1/12; B26D 5/08

(52) U.S. Cl. 407/30; 83/581

(57) ABSTRACT

Improvements are provided in metal cutting machines of the type having an overhead circular saw assembly mounted via a pivot joint onto a turntable set into a platform to which a pair of fences may be deployed. The improvements, overcoming limitations that restrict angle cuts to 45 degree maximum from straight in known metal cutting machines, enable metal cutting at practically any angle as well as single or multiple slotting at 90 degrees from straight. There is no fastening hardware passing through the turntable or other structural anti-rotational obstructions as found in known metal cutting machines, thus the turntable, along with the saw assembly, can be rotated full 360 degrees relative to the platform to any desired angle without restriction. In a preferred embodiment, a pair of fence blocks may be secured to the platform at opposite sides of the turntable via bolts engaging keeper strips captivated in either of two pairs of inverted T channels machined into the platform: one at a central location for regular cutting up to 60 degrees from straight and the other offset to the rear for straight-cutting wide stock. The fences and keeper strips can be transferred rapidly between these two locations. A hold-down screw near the inner end of each fence block locks the turntable to lock it at any selected angle of rotation. A third fence mounting location, offset forward of the main central fence location, for cutting at increased angles from straight, is provided by configuring a pair of simple channels at that location with threaded mounting holes at their bottom level.

### FIELD OF THE INVENTION

The present invention relates to the field of metal cutting machines, and more particularly it relates to improvements in overhead circular cold metal cutting machines with regard to workpiece size and range of cutting angle.

### BACKGROUND OF THE INVENTION

In the field of metal cutting a particular type of cold metal cutting machine has evolved to a somewhat standard status; typically an overhead type with a circular saw blade, e.g. 14 inch diameter, running at low speed, typically usually within a range of 20 to 120 r.p.m. and typically equipped with a recycling liquid coolant system to prevent overheating of the blade. The cutting operation can be considered a metal milling operation.

In comparison to well-known woodworking circular saws that have been highly developed for light weight and versatility, the much greater difficulties of cutting hard metal such as stainless steel require metal cutting machines to be designed and built with rugged construction that tends to be much heavier, more costly and less versatile.

### DISCUSSION OF KNOWN ART

The evolution of machines for cold cutting of metal stock such as tubing, rods and bars has led to a typical structure that has become somewhat standard state of the art for many years.

FIG. 1 is a simplified representation of a typical cold metal cutting machine 10 of known art based on design that originated in Europe in the 1950's. Metal sawing machines of this general type have been marketed in the U.S. as Haberle since 1982 and as Doringer since 1994.

A cast iron platform 12, mounted on a base cabinet 14, is configured with a large machined circular opening into which is fitted a cast iron turntable 16 that is supported on ledge around the circular opening so that the surface of turntable 16 is flush with the surface of the platform 12. A pair of fence blocks 18′ and 18″, located on the top surface of the platform 12 and of turntable 16, are each fitted with a locking lever, e.g. lever 18A shown on fence block 18′, by which the fence blocks 18′ and 18″ and the turntable 16 can be locked in place with the work platform 12. A threaded shaft attached to lever 18A engages a threaded hole in a fixed bushing cast as part of platform 12 that extends upwardly, into arcuate slot 16B′ configured in the turntable 16A as shown. A second similar bushing extends upwardly into slot 16B″.

A workpiece 20, typically a metal bar or rod, is clamped in place by a clamp jaw 22 which is locked in place by a mechanism (not shown) that can be manual, electrical, pneumatic or hydraulic.

A saw assembly 24, including a motor 24A and reduction gearbox 24B, is mounted onto turntable 16 via a pivot assembly 24C which allows the circular blade 24C to be lowered into the workpiece 20 and into slot 16A by manipulation of lever 24E.

When turntable 16 is unlocked by releasing lever 18A′, the turntable 16 along with motor assembly 24 can be rotated about the central axis of turntable 16, while the fences 18′ and 18″ remain affixed to platform 12, to enable angle cuts in addition to the centered position shown for straight cuts, i.e. perpendicular to the fences 18′ and 18″ (0 degrees). However angle cuts are limited to a maximum of +/−45 degrees from straight by an internal rib structure in platform 12 and by the fixed bushings extending up into slots 16B′ and 16B″ in turntable 16.

To avoid blade overheating even at the relatively low blade speeds, metal saws are often equipped with provision to apply liquid coolant to the blade.

Inherently in metal cutting, due to the slow blade speed and hardness of the workpiece, there is a strong tendency for chatter type of vibration between the workpiece 20 and the saw blade. Consequently a very massive and rugged structure is required in the mechanical linkage path that includes the motor/gearbox assembly, its pivoted mounting mechanism, the turntable, platform, and the fence/clamping mechanism which is typically attached to both the turntable and the platform. The motor/gearbox assembly alone does not have nearly enough mass to prevent chattering as it does in woodworking saws, so the saw assembly must be very tightly coupled to the turntable and platform, and these function best when even further stabilized by massive support from a heavy base cabinet 14. With these requirements satisfied, the weight of a metal cutting machine typically amounts to 800 to 1,000 lbs.

Each structural element in the metal cutting machine is critical for a successful product. It has been found necessary to keep the pivot mechanism as simple, solid and short-coupled as possible, with the pivot point as low as possible close the turntable and platform.

In conventional metal cutting machines, these stringent requirements have been satisfied only at the expense of a functional/structural tradeoff that resulted in limiting the rotation angle of the turntable base and thus the cutting angle to +/−45 degrees from straight. This severely limits the utility of the metal cutting machine and precludes the capability of cutting at steeper angles and ripping or slotting, i.e. at 90 degrees from straight, even though there are often requirements for such operations on metal. The 45 degree angular limitation has been accepted as an unavoidable tradeoff in the attainment of a sufficiently solid overall structure that has been deemed necessary to provide uniform and accurate cutting performance due to stabilization and suppression of vibration and chattering.

U.S. Pat. No. 4,002,094 to Erikson et al discloses an overhead METAL SAW that provides angular positions up to fully perpendicular from straight for ripping. Instead of mounting the saw assembly directly onto the turntable as in the example described above, it is mounted via a relatively long linkage extends from the lower portion of the pivot assembly to an axis beneath the platform coaxial with the turntable.

Versions of this type of metal saw have been marketed as lower cost alternatives with increased angular capability, however the more rugged machines continue to claim superiority

### OBJECTS OF THE INVENTION

It is a primary object of the present invention to provide an improvement in metal sawing machines of known art that enables the cutting of angles greater than 45 degrees from straight.

It is a further object that the improvement also provide a cutting angle up to 90 degrees from straight for cutting slots parallel to the workpiece.

It is a further object to provide the foregoing improvements in angular capability while retaining excellent anti-chatter performance through high integrity in the mechanical linkage between workpiece fences and the saw assembly, which includes the platform, turntable and pivot joint supporting the saw assembly.

### SUMMARY OF THE INVENTION

The abovementioned objects have been accomplished by the present invention of improvements in metal cutting machines of the type having an overhead circular saw assembly mounted via a pivot joint onto a turntable set into a platform to which are secured a pair of fences.

A novel system of turntable mounting and fence block attachment overcomes limitations that have restricted angle cuts to 45 degrees maximum from straight in known metal cutting machines. The invention enables metal cutting at practically any angle as well as single or multiple slotting at 90 degrees from straight. There is no fastening hardware passing through the turntable or other rotational obstructions as found in known metal cutting machines, thus the turntable, along with the saw assembly, can be rotated relative to the platform to any desired angle without restriction.

A pair of fence blocks are secured to the platform at opposite sides of the turntable via bolts engaging keeper strips captivated in either of two pairs of inverted T channels machined into the platform: the main pair at a central location for regular cutting up to 60 degrees from straight and the other pair offset to the rear for straight-cutting wide stock. The fences and keeper strips can be transferred rapidly between these two locations.

With the fence blocks bolted in place with their inner ends extending over the turntable, a hold-down screw near the inner end of each fence block is tightened down onto the turntable to lock it in any selected angle of rotation.

A third fence mounting location, for cutting at increased angles from straight, is implemented with a pair of simple channels located forward of the main pair of inverted T channels.

### BRIEF DESCRIPTION OF THE DRAWINGS

The above and further objects, features and advantages of the present invention will be more fully understood from the following description taken with the accompanying drawings in which:

FIG. 1 is an isometric view of a metal cutting machine of known art.

FIG. 2 is an exploded isometric view of the main mounting components of a metal cutting machine in accordance with the present invention.

FIG. 3 is an isometric view of the major components of FIG. 2 assembled together with turntable set at 0 degrees for straight cutoff, with a pair of fence blocks in the main centrally located pair of inverted T channels.

FIG. 4 is a plan view of the subject matter of FIG. 3 showing the a workpiece clamped to both fence blocks.

FIG. 5 shows the basic setup as in FIG. 4, but with the turntable and saw oriented to cut at 60 degrees from straight and the workpiece clamped to one fence block.

FIG. 6 is a plan view as in FIGS. 4-5 but with the turntable and saw oriented to cut at 65 degree from straight, using alternative fence blocks deployed at the forward channel location and the workpiece clamped to one fence block.

FIG. 7 is a plan view as in FIGS. 4-6 but showing the location of the turntable and saw blade set for slotting, i.e. cutting at 90 degrees from straight, with a single fence block set in the rearward alternative inverted T channel.

FIG. 8 is a plan view as in FIGS. 4-7 but showing a pair of fence blocks set in the rearward inverted T channels for straight cutoff of an unusually wide workpiece.

### DETAILED DESCRIPTION

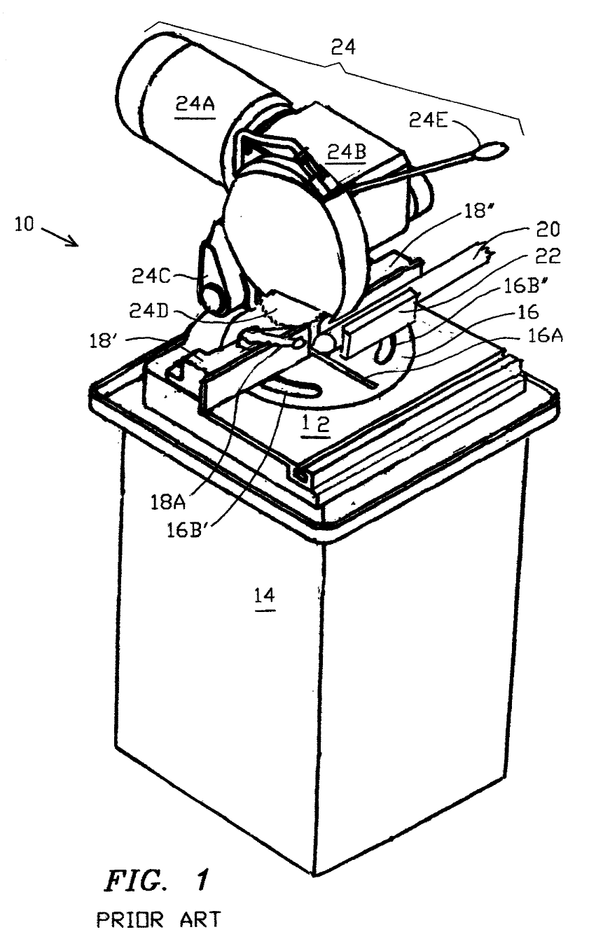

FIG. 1 is an isometric view representing a metal cutting machine of known art as described above in connection with the discussion of known art.

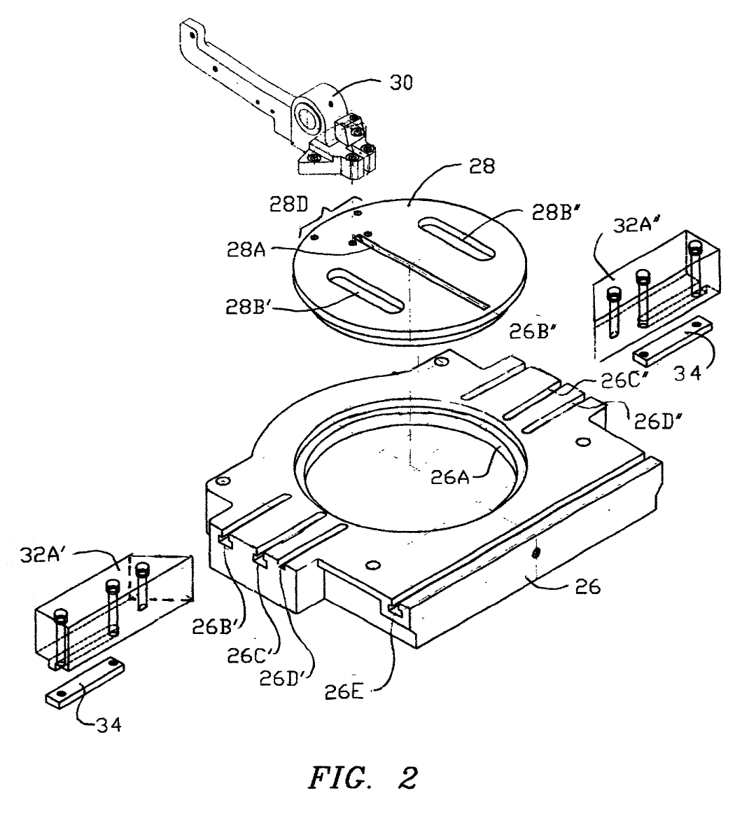

FIG. 2 is an exploded isometric view of the main mounting and fence components of a metal saw in accordance with the present invention. A cast iron platform 26 with a flat top surface is machined to provide a central circular turntable opening 26A with a stepped edge, as in FIG. 1. In departure from FIG. 1, platform 26 is further machined to provide a set of six fence-locating channels, three on each side flanking the turntable opening 26A: on the left hand side, inverted T shaped channels: 26B′, 26C′ and simple rectangular channel 26D′ extending inwardly from the left hand edge and corresponding channels 26B″, 26C″ and 26D″ extending inwardly from the right hand edge; all six of these channels terminate at locations short of the turntable opening 26A, as shown.

A turntable 28, made from cast iron and machined to provide an accurate stepped edge fitting opening 26A, is configured with a central slot 28A dimensioned to clear the saw blade, and a pair of straight slots 28B′ and 28B″ which provide convenient disposal into a container below for metal chips and waste coolant from the cutting process.

At a location near the rear of the turntable 28 are seen a cluster of four bolt holes 28D for attachment of a pivot joint member 30 of known art shown in dashed lines, with an extending arm for attachment of a counterbalancing spring of known art used in conjunction with a conventional metal saw motor/gearbox assembly such as assembly 24 in FIG. 1.

To the left and right are shown a pair of fence blocks 32A′ and 32A″ along with rectangular keeper strips 34′ and 34″ which are dimensioned to fit into the wide lower portion of inverted T channels 26B′, 26C′, 26B″ and 26C″, and which are configured with threaded holes to engage a pair of bolts extending down from each of the corresponding fence blocks 32A′ and 32A″ above. Fence blocks 32A′ and 32A″ are configured on their bottom side with an integral key that fits into the narrow upper portion of the inverted T channels 26B′, 26C′, 26B″ and 26C″ and into the plain rectangular slots 26D′ and 26D″, serving to solidly stabilize the fence blocks 32A′ and 32A″ in place on the platform 26.

Inverted T channel 26E, extending fully across the front region of platform 26 as in FIG. 1,serves to anchor known clamping “vice” mechanisms, that can be manual, electrical, pneumatic or hydraulic, and that are conventionally made and arranged to act on a clamp jaw for holding a workpiece in place against the fence blocks 32A′ and 32A″.

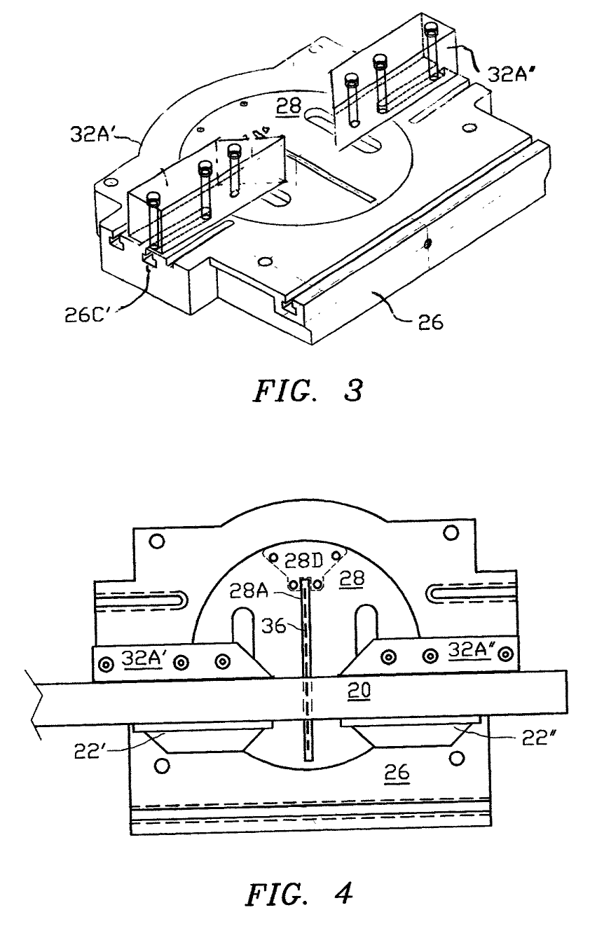

FIG. 3 is an isometric view showing the major components from FIG. 2 assembled to form the mounting base of the present invention for supporting a metal sawing machine such as saw assembly 24 in FIG. 1, set up for straight cutoff (0 degrees). Fence blocks 32A′ and 32A″ are deployed symmetrically in the main pair of inverted T channel locations, e.g. channel 26C′, anchored firmly on platform 26 by the keeper strips (34, FIG. 2) inserted into the channels beneath fence blocks 32A′ and 32A″, which are locked in place by tightening the two bolts in each engaging the threaded holes in the keeper strips. Then when turntable 28 has been rotated to the desired orientation, in this case set for straight cutoff, the third bolt in each fence block 32A′ and 32A″ is tightened down against turntable 28, locking it in place against rotation or any other movement.

FIG. 4 is a plan view of the metal saw mounting base of FIG. 3, again shown with the fence blocks 32A′ and 32A″ secured in location above the main central inverted T channels (26C′ and 26C″, see FIG. 2). The turntable 28 along with saw slot 28A and saw blade 36 locked in a rotational setting of 0 degrees for a normal cutoff angle; this can be performed on a workpiece 20 up to about 6 inches wide with this setup, which utilizes a pair of clamp jaws 22″ and 22″.

The outline around hole cluster 28D indicates the extent of the swivel saw assembly support structure that requires clearance relative to the fence blocks 32A′ and 32A″.

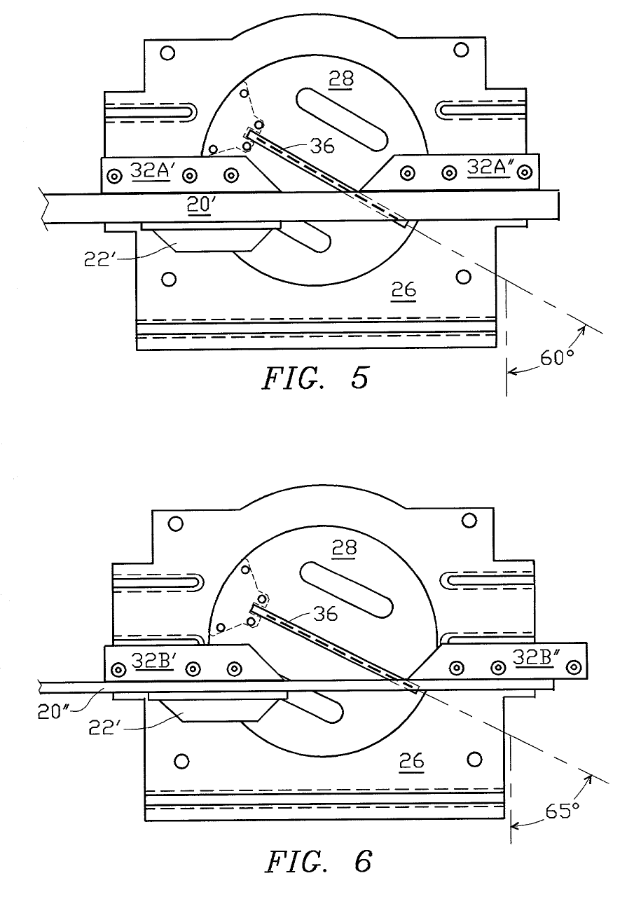

FIG. 5 is a plan view as in FIG. 4 but with the turntable 28 rotated and locked with the saw blade 36 set for a cut that is 60 degrees from straight as indicated. This angle is limited by loss of clearance between the swivel saw assembly support structure and the fence block.

At this 60 degree angle setting, cutoff can be performed on a workpiece 20″ up to about 2½ inches wide by 2½ inches high, which may be held by a single clamp jaw 22′ as shown.

FIG. 6 is a plan view as in FIGS. 4-5 but showing the turntable 28 further rotated so that the saw blade 36 is angled 65 degrees from straight. To accomplish this additional rotation, a pair of alternative fence blocks 32B′ and 32B″ configured with mounting holes located off-center as shown, are set in the forward pair of channels (26D′ and 26D″ in FIG. 2) with fence block 32B″ offset outwardly and the workpiece held by a single clamp 22″ as shown. With this setup, cutoff at 65 degrees from straight can be performed on a workpiece 20″ up to about ½ inch wide.

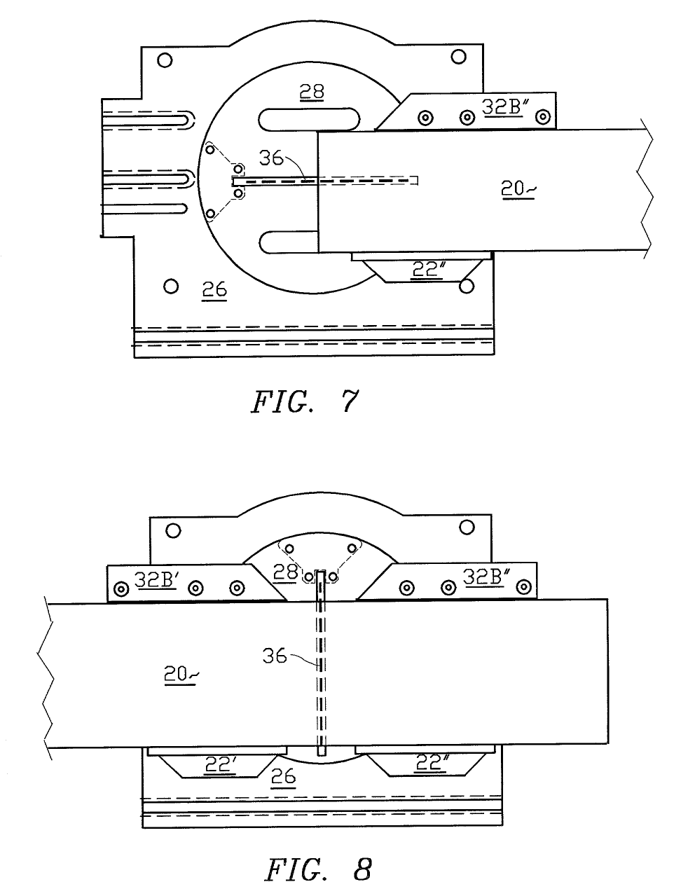

FIG. 7 is a plan view as in FIGS. 4-6 but showing the location of the turntable 28 and saw blade 36 set for slotting, i.e. cutting at (or about) 90 degrees from straight into the end of a workpiece 20^{˜} held by a clamp jaw 22″ and a single fence block, shown as 32B″ of the alternative offset type, located at one of the rearward inverted T channels. Depending on the required location of the cut, the fence block deployed could be the regular non-offset type. Amongst other options, the fence block may be faced with a spacer strip, or vices with clamp jaws may be located in both the front and rear position to allow rapid multiple slotting.

FIG. 8 is a plan view as in FIGS. 4-7 but showing the turntable 28 and saw blade 36 set for straight cutoff of an unusually wide workpiece 20^{˜} held by a pair of clamp jaws 22′ and 22″ and a pair of fence blocks 32B′ and 32B″ of the alternative offset type with offset hole locations, set symmetrically in the rearward inverted T channels. With this setup, straight cutoff can be performed on a workpiece 20^{˜} up to about 9½ inches wide.

The invention is not confined to the particular shape of the fence blocks as shown with a 45 degree chamfer at one end; while this shape is generally considered optimal for most requirements, the invention can be practiced with custom fence blocks of different configuration; e.g. with ends at any lesser or greater angle for special requirements, e.g. 90 degrees for straight cutoff.

The particular arrangement of inverted T and regular channels shown for locating and anchoring the fence blocks is described as an illustrative preferred embodiment exemplifying many alternative arrangements that could hold the workpiece in an equivalent manner for practicing the invention.

The disclosed method of locking the turntable in place by screws at the inner ends of the fence blocks is convenient since it allows the turntable to be released and rotated with the fence blocks remaining locked in place. The invention could be practiced with alternative methods of locking or clamping the turntable in place against rotation

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed is:

1. An improvement in a cold metal cutting machine of a type having a saw assembly pivotedly mounted on a circular turntable set into a substantially horizontal platform configured with substantial left/right general symmetry along a horizontal primary axis, including a circular blade in a vertical disposition and a workpiece clamping mechanism, the improvement comprising:
the circular turntable and the platform being configured and mutually engaged in a manner to allow the turntable be adjustably rotatable to any angle throughout 360 degrees relative to the platform;
a fence block including fence attachment means for affixing said fence block in an easily-removable manner in a desired location on the platform parallel to the horizontal axis while allowing rotational adjustment of said turntable; and
turntable locking means for locking said turntable to the platform after adjustment of said turntable to a desired angle of rotation.

2. The improvement in a cold metal cutting machine as defined in claim 1 wherein said fence block attachment means comprises:
the platform being configured with at least one co-linear pair of inverted T channels flanking the turntable on opposite sides thereof and disposed on a line parallel to the horizontal primary axis of the platform, each inverted T channel having in cross-section a relatively wide lower portion communicating with a relatively narrow upper portion;
an elongate keeper strip dimensioned to slidingly fit into the wide lower portion of the inverted T channel and configured with a pair of threaded holes located near opposite ends thereof,
a pair of attachment machine screws, traversing a corresponding pair of clearance holes provided in said fence block, made and arranged to extend downwardly therefrom, to each threadedly engage one of the threaded holes in said keeper strip and to be drivable from above in a manner to fasten said fence block securely onto the platform in a manner that allows adjustable rotation of the turntable.

3. The improvement in a cold metal cutting machine as defined in claim 1 wherein said turntable locking means comprises a third threaded bolt deployed in a threaded hole provided near an end of said fence block, made and arranged to be tightened down onto said turntable and to thusly secure said turntable to the platform in a manner to prevent any relative movement including rotation therebetween.

4. The improvement in a cold metal cutting machine as defined in claim 3 comprising:
the platform being configured with two pairs of inverted T channels including a primary pair located co-linearly on a line that is parallel to the main horizontal axis and that traverses a central region of the turntable, and a secondary pair located rearward of and parallel to the primary pair; and
two said fence blocks deployed in mirror-image collinear relationship parallel to the horizontal main axis; each secured in place on the platform by one of said keeper strips disposed in a corresponding one of a selected pair of the inverted T channels.

5. An improvement in a cold metal cutting machine of a type having a saw assembly pivotedly mounted on a circular turntable set into a substantially horizontal platform configured with substantial left/right general symmetry along a horizontal primary axis, including a circular blade in a vertical disposition and a workpiece clamping mechanism, the improvement comprising:
the circular turntable and the platform being configured and mutually engaged in a manner to allow the turntable be adjustably rotatable to any angle throughout 360 degrees relative to the platform;
a mirror image pair of fence blocks each configured with a pair of vertical bolt clearance holes, and a threaded bolt hole near an end of each said fence block including
a pair of threaded bolts extending downwardly each through a vertical clearance hole configured in each said fence block, and a third threaded bolt engaged in vertical threaded hole configured in each said fence block near an end thereof;
at least two pairs of inverted T channels configured in the platform, each having a wide lower portion and a narrow upper portion, flanking the turntable on opposite sides thereof, each pair being disposed on a line parallel to the primary axis of the platform;
an elongate keeper strip associated with each of said fence blocks, located in the narrow portion of a corresponding one of said inverted T channels, configured with a pair of threaded holes one near each end thereof, and captivated to said fence block via threaded engagement of the pair of threaded bolts in a manner and to secure the corresponding fence block to the platform, upon tightening the pair of threaded bolts, in an easily-removable manner, in a desired location on the platform parallel to the horizontal main axis while allowing rotational adjustment of the turntable; and
a threaded bolt engaged in the threaded hole near the end of each of said fence blocks, made and arranged to clamp down on said turntable when tightened, so as to lock said turntable in a selected rotational disposition.
